(19) United States
(12) Patent Application Publication
(10) Pub. No.: US 2015/0151305 A1
(43) Pub. Date: Jun. 4, 2015

(54) DEVICE FOR DISSIPATING AND GRINDING THE WET PART OF URBAN WASTE

(71) Applicant: Luigi SAUVE, Forano (RI) (IT)

(72) Inventor: Luigi Sauve, Forano (IT)

(21) Appl. No.: 14/418,055

(22) PCT Filed: Aug. 1, 2013
(86) PCT No.: PCT/IB2013/001684

§ 371 Date: Jan. 28, 2015

(30) Foreign Application Priority Data
Aug. 2, 2012 (IT) CZ2012A000010

(51) Int. Cl. B02C 18/00

(52) U.S. Cl. CPC B02C 18/0084

(57) ABSTRACT

A device for dissipating and grinding the wet part of urban waste includes:—an upper container able to be filled with the wet part of urban waste;—an electric motor coupled to the upper container and able to grind the wet part; and—a lower reservoir for the collection of the grinded wet part. The lower reservoir is detachable and able to be directly emptied, through the bathroom toilet, into the sewer pipes and, through the sewer pipes, into the sewage treatment plant systems.

### BACKGROUND

### Technical Field

The present invention relates to a device for dissipating and grinding the wet part of urban waste.

In particular, the present invention relates to a device for dissipating and grinding the wet part of urban waste, of the type that are normally used for a single house or for restaurants or for entire blocks of flats.

2. Description of the Related Art

As is known, the urban solid waste are separated into the following categories: wet; glass; paper and paper products; iron; plastic and derivatives; undifferentiated. In particular, glass, paper, iron and plastic are used for recycling operations, after having been collected within ecological islands. Instead, the wet part can't be recycled because of the fast decay, resulting in issuance of bad odor and possible danger to human health. In addition, when the wet passes to the so-called percolation phase becomes extremely dangerous for the aquifers. Moreover, an important issue of the wet waste is the saturation of landfills and the environmental contamination, especially of squares and streets of our cities.

These issues have been addressed until now proposing two types of solutions for wet waste sinks household sinks and sinks especially designed for the restaurant industry, both operating in the same manner. Basically, the sink is applied to the exhaust pipe of the kitchen sink and the operation of elimination of wet waste comprises the steps of manually pushing the wet waste in the exhaust pipe of the kitchen sink and to operate the sink that makes liquid the wet waste.

Although effective under several aspects, the described sink solutions are affected by several problems, including the fact that to work well these sinks employ a large amount of water for the whole period in which they are in operation, resulting in high dilution of the treated wet, in less effectiveness during the treatment and in a significant consumption of potable water.

Furthermore, the exhaust pipe of the kitchen has normally a diameter that does not exceed 2 inches and runs long distances before entering the downpipe, so it could be easily subject to clogging. This implies that some wet residues, having big sizes compared to the exhaust pipe or big consistency compared to the dissipation capacity, for example in the case of bones of meat or other consistent waste, must be traditionally disposed.

### BRIEF SUMMARY

An aim of the present invention is to provide a device for dissipating and grinding the wet part of urban waste having no limitation due to the size of the exhaust pipe and avoiding to use large amounts of water.

According to the present invention, a device for dissipating and grinding the wet part of urban waste is realized, as defined in claim 1.

### BRIEF DESCRIPTION OF THE SEVERAL VIEWS OF THE DRAWINGS

For a better understanding of the present invention a preferred embodiment is described, by way of non limitative example, referring to the accompanying drawings, in which:

FIG. 1 shows a first schematic front view of a device, without motor, for dissipating and grinding the wet part of urban waste, according to the invention;

FIG. 2 shows a second schematic front view of the device, with motor, for dissipating and grinding the wet part of urban waste, according to the invention;

FIG. 3 shows a section view of the different components of the device for dissipating and grinding the wet part of urban waste, according to the invention.

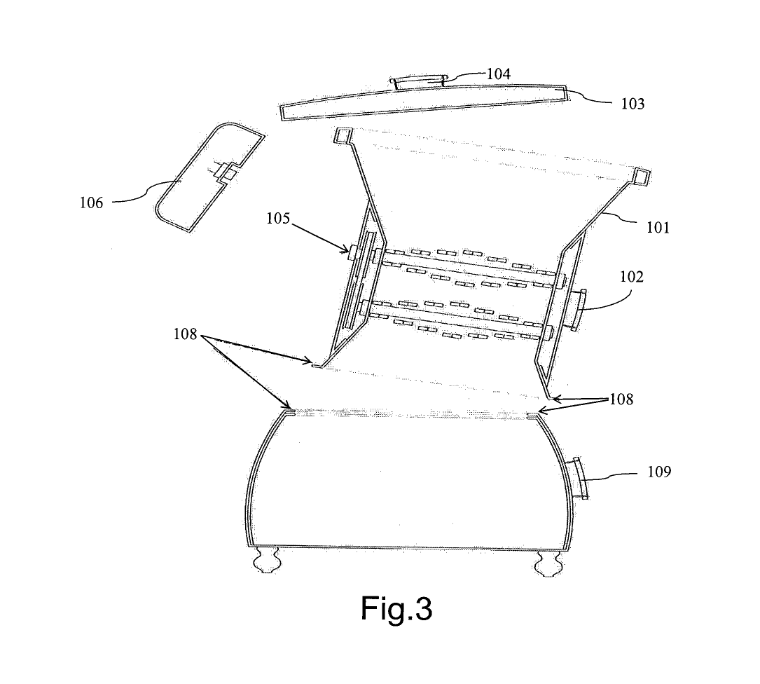

### DETAILED DESCRIPTION

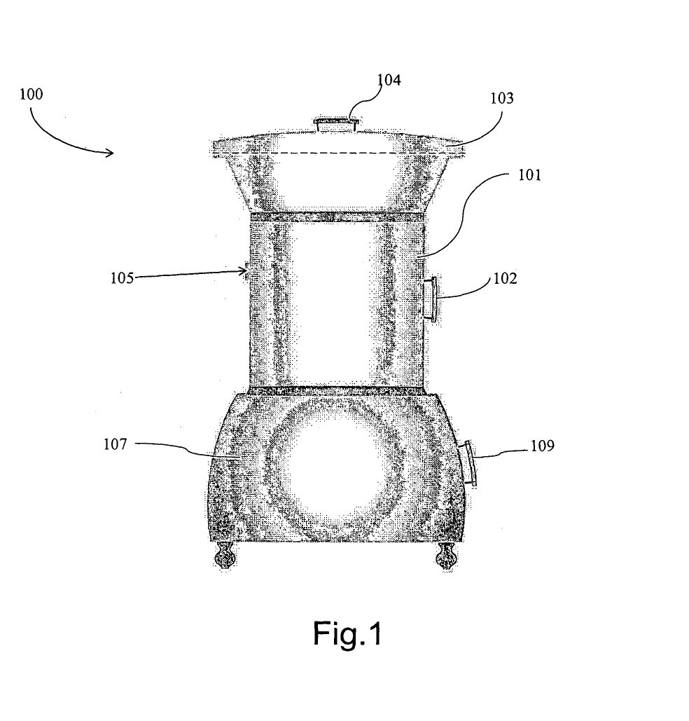

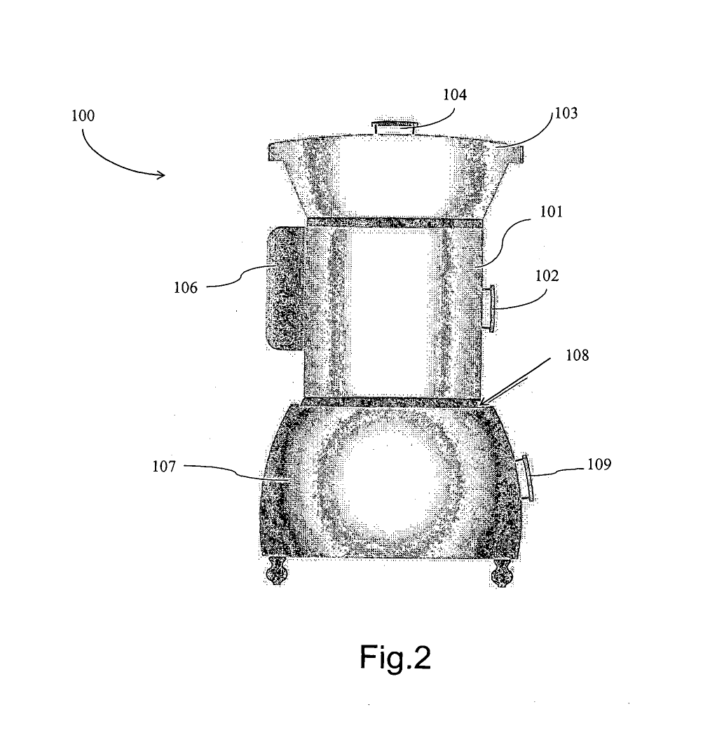

Referring to those figures, and in particular to FIGS. 1 and 2, a device 100 for dissipating and grinding the wet part of urban waste is shown, according to the invention. In more details, the device 100 for dissipating and grinding the wet part of urban waste, according to the invention, comprises three separable and modular parts. In particular, the device 100 comprises an upper container 101 used for the filling with the wet part of urban waste, an electric motor 106 coupled centrally to the upper container 101 and used in the operation of grinding the wet part of urban waste introduced into the container 101, and a lower reservoir 107 used to collect the grinded wet part.

The container 101 is provided with a handle 102 and is equipped with a cover 103, which is also provided with a handle 104. The cover 103 comprises at least one sensor, not shown in the figures, which, in the presence of a predetermined amount of waste material within the container 101, is configured to detect the hermetic closed configuration of the cover 103 on the container 101. Furthermore, the container 101 is equipped, in the central portion of the bell and in opposite position with respect to the handle 102, with a protrusion 105 useful for the coupling of the electric motor 106. More in details, the electric motor 106 is interconnected with a central portion of the container 101 by screwing to the protrusion 105, and is used to grind the wet waste introduced in the container 101, depending on a signal received from the sensor comprised in the cover 103.

Advantageously according to the invention, the container 101 can be simply unscrewed from the motor 106 using the handle 102 after the grinding operation has terminated.

Advantageously according to the invention, the device 100 is safe since the motor 106 is not activated if the cover 103 is not hermetically closed and the sensor doesn't send the activation signal to the motor 106.

The lower portion of the device 100 is used to collect the grinded wet material and comprises a reservoir 107 for collecting such grinded wet material received from the container 101 to which it is coupled by interconnection means 108, such as a male bayonet coupling in the reservoir 107 and a female bayonet coupling in the container 101. The reservoir 107 is equipped with a handle 109 that facilitates taking the reservoir 107, once it is unscrewed from the container 101 to be emptied when the grinding operation is ended.

According to an aspect of the invention, the container 101 is stainless steel made. According to an aspect of the invention, the container 101 has a cylindrical shape slightly flared at the top.

According to another aspect of the invention, the container 101 has a bell shape. According to an aspect of the invention, the container 101 has a maximum capacity equal to 2 liters.

According to a further aspect of the invention, the size of the container 101 is such as to reasonably contain the wet part of a meal of an average family comprising 4 people, so as to require only one emptying per meal.

According to an aspect of the invention, the electric motor 106 has a cylindrical shape and works with current monophasic at 220 V.

According to an aspect of the invention, the reservoir 107 is stainless steel made and has a cylindrical shape.

According to another aspect of the invention, the reservoir 107 has a maximum capacity equal to 3 liters.

According to a further aspect of the invention, the weight of the reservoir 107 has a weight less than or equal to 4 Kg, so as to allow easy movement and emptying.

According to an aspect of the invention, the device 100 has a height comprised between 40 cm and 45 cm.

According to another aspect of the invention, the device 100 has a diameter comprised between 18 cm and 23 cm.

According to a further aspect of the invention, the device 100 has a weight-load comprised between 4,500 kg and 5,500 kg.

In use, the wet part of urban waste is introduced in the container 101 meanwhile it is produced. When the container 101 is full, the cover 103 is closed triggering a contact with the electric motor 106. Therefore the motor 106 is turned on to perform the grinding of the wet part of the waste introduced and is turned off at the end of the grinding process. When the grinding is finished, the reservoir 107 full of the grinded material is emptied into a toilet of a bathroom. In this way, the grinded wet part of the waste is discharged as waste water directly, through the bathroom toilet, into the sewer pipes, having a diameter equal at least to 100 mm, and, through the sewer pipes, into the sewage treatment plant systems or city depurators.

Advantageously, according to the invention, the reservoir 107 and the container 101 can be easily rinsed before being reused.

Advantageously, according to the invention, by screwing the reservoir 107 to the container 101, the device 100 is ready again for a next use.

Advantageously, according to the invention, all components, the container 101, the motor 106 and the reservoir 107, comprised inside the device 100 are easy to disassemble and replace.

Advantageously, according to the invention, the device 100 for dissipating and grinding the wet part of urban waste may be dimensioned to be used by an entire building with several floors. In this case, in particular, it is necessary to install, in the building, an exhaust descending column, having a diameter at least equal to 100 mm, placed at the level of the kitchen of each flat and conveniently inserted into the cabinet of a kitchen and covered by a lid or a cover. Therefore the wet produced in the kitchen, even during the phase of preparation of food, can arrive, via the exhaust descending column, at the ground floor or garage floor, directly into the container 101 of a suitably dimensioned device 100, then grinded by the motor 106 and directly discharged into the sewage treatment plant systems.

Advantageously, according to the invention, the wet part of the urban waste can be disposed through the entire column of kitchens of a building using a single device 100 per building or per kitchens column having a nearby sewer collector, so as to avoid to install a device 100 in each flat.

The Applicant has carried out a verification of the water functioning of the device for dissipating and grinding the wet part of urban waste, according to the invention. In particular, it has been considered that the normal water endowment for a city is equal to 250 liters per person per day, the 80% of that returning to the sewer, which means that for every inhabitant it is expected a spill into the public sewer equal to 200 liters per person per day. As a consequence, for a family comprising 4 people, the supplied water is calculated according to the following formula:

4 persons×250 lt/person/day=1000 lt/family/day,

with a return to sewer R equal to 800 lt/family/day. Moreover, considering that the number of times of toilet use, for bodily needs, is equal to 5 per person per day and that the average flow of the toilet flushing cistern is equal to 12 lt, it is possible to calculate that the return from toilet organic wastes is equal to:

5 times×4 persons×12 lt/exhaust=240 lt/fam/day.

Furthermore, the value of the return to the sewer for discharging inorganic material rich of chemicals arising from domestic activities, as personal hygiene, cleaning floors, washing machines, dishwashers, and preparation of food, can be calculated as the difference between the sewer return R and the sewer return on R sewer from toilet organic wastes:

800 lt/fam/day−240 lt/fam/day=560 lt/fam/day.

Using the device for dissipating and grinding the wet part of urban waste according to the invention, it has been calculated that organic discharges 4 times a day (breakfast, lunch, dinner+1 time for safety) are equal to:

4 times×12 lt/fam/day=48 lt/fam/day.

As a consequence, the incidence of the introduction of the device for dissipating and grinding the wet part of urban waste, according to the invention, minimally affects the water consumption, only the 5%, and the consequent return in sewer.

Therefore, with the device for dissipating and grinding the wet part of urban waste according to the invention a greater amount of organic waste than the current can be supplied directly to a final receptor, or, to the urban sewage treatment system, facilitating the purification process, better offsetting the submission of the inorganic waste or chemicals.

Another advantage of the device for dissipating and grinding the wet part of urban waste according to the invention consists in the fact that, once the device is widespread in large scale, allows to eliminate the problem of saturation of the landfill, by forwarding to the depurator both the waste water and the conveniently treated wet waste.

Another advantage of the device for dissipating and grinding the wet part of urban waste according to the invention is that it is possible to abolish landfills for the wet and the laborious and smelly composting processes.

Another advantage of the device for dissipating and grinding the wet part of urban waste according to the invention is that it is possible to centralize all waste, both black water and wet, only inside the depurators.

Moreover, the device for dissipating and grinding the wet part of urban waste according to the invention allows to eliminate any type of waste collection, garbage trucks, containers, and others.

Another advantage of the device for dissipating and grinding the wet part of urban waste according to the invention is that it allows to dedicate more space for locating the containers for the collection of paper, plastic, glass, iron.

At the end, with the device for dissipating and grinding the wet part of urban waste according to the invention an improvement of the functionality of the depurators is obtained due to the greater load of organic materials delivered.

It should be clear that other modifications and embodiments carried out to the described device for dissipating and grinding the wet part of urban waste can be done falling within the scope of the present invention, as defined in the appended claims.

1. A device for dissipating and grinding a wet part of urban waste comprising:
an upper container able to be filled with the wet part of urban waste;
an electric motor coupled to the upper container and able to grind the wet part; and
a lower reservoir for the collection of the grinded wet part; wherein:
the upper container, the electric motor, and the lower reservoir are configured to be disconnected from each other, so that the lower reservoir is able to be directly emptied, through a bathroom toilet, into sewer pipes and, through the sewer pipes, into sewage treatment plant systems; and
the upper container comprises at least one sensor able to detect a hermetic closure of the container at an end of filling with the wet part of urban waste and to activate the electric motor.

2. (canceled)

3. The device for dissipating and grinding the wet part of urban waste according to claim 1, wherein the container is made of stainless steel.

4. The device for dissipating and grinding the wet part of urban waste according to claim 1, wherein the container has a cylindrical shape slightly flared at a top.

5. The device for dissipating and grinding the wet part of urban waste according to claim 1, wherein the container has a bell shape.

6. The device for dissipating and grinding the wet part of urban waste according to claim 1, wherein the container is provided with a cover.

7. The device for dissipating and grinding the wet part of urban waste according to claim 1, wherein the upper container has a capacity equal to at least 2 liters.

8. The device for dissipating and grinding the wet part of urban waste according to claim 1, wherein the electric motor has a cylindrical shape and works with monophasic current at 220 V.

9. The device for dissipating and grinding the wet part of urban waste according to claim 1, wherein the lower reservoir is made of stainless steel and has a cylindrical shape.

10. The device for dissipating and grinding the wet part of urban waste according to claim 1, wherein the reservoir has a capacity at least equal to 3 liters.

11. The device for dissipating and grinding wet part of urban waste according to claims 1, characterized in having a weight-load comprised between 4,500 kg and 5,500 kg.

12. A method for dissipating and grinding a wet part of urban waste comprising the steps of:
collecting the wet part of urban waste;
grinding the wet part;
collecting the grinded wet part;
starting the step of grinding the wet part at a maximum value of the collected wet part; and
discharging the grinded wet part, through a bathroom toilet, into sewer pipes and, through the sewer pipes, into the sewage treatment plant systems.
